(19) United States
(12) Patent Application Publication
(10) Pub. No.: US 2007/0177023 A1
(43) Pub. Date: Aug. 2, 2007

(54) System and method to provide an adaptive camera network

(76) Inventors: Allyson J. Beuhler, Woodridge, IL (US); Gregory A. Kujawa, St. Charles, IL (US); King F. Lee, Schaumburg, IL (US); David L. Weiss, Roselle, IL (US)

Correspondence Address: MOTOROLA, INC., 1303 EAST ALGONQUIN ROAD, IL01/3RD, SCHAUMBURG, IL, 60196, US

(21) Appl. No.: 11/344,990

(22) Filed: Jan. 31, 2006

(51) Int. Cl. H04N 5/232

(52) U.S. Cl. 348/211.3

(57) ABSTRACT

A system and method for providing an adaptive camera network is provided. The invention discloses a camera network comprising a plurality of cameras, wherein each camera in the network comprises a plurality of applications that include a first application for performing a primary function and a second application for changing the primary function and a trigger based on an event, the trigger activating the second application in at least a portion of the plurality of cameras.

### FIELD OF THE INVENTION

The present invention relates generally to a camera network and particularly to a camera network controlled by a communication system.

### BACKGROUND OF THE INVENTION

Most imaging systems designed for security and surveillance are based on a CCD camera, a frame grabber, and a separate personal computer. Video images are streamed to the computer (located either locally or remotely) and image analysis, image processing, and object recognition on carried out via software programs on the personal computer. Intelligent or “smart cameras” are also becoming more popular. In these systems, the image sensor and processor are integrated into one package. The processor can be used for image processing, image compression, image analysis, or object detection. The advantage of smart cameras is that high bandwidth video does not have to be streamed to a computer. Much of the processing can be done on camera thus increasing available bandwidth for other network applications.

Networks of conventional analog cameras and smart cameras for security, tolls, road use, red light offenses, face recognition and automated license plate recognition are known in the art. These camera networks can be linked to communication networks and routinely send information back to a central computer. However, the cameras do not communicate with each other in an intelligent fashion or have the ability to self-initiate changes in the local camera network. For example, during a time critical event such as a terrorist attack, kidnapping, amber alert, or drive by shooting, it is difficult for police officers to rapidly communicate a description relating to a suspect before the suspect leaves a local area. A “smart” camera network could begin “searching” for the suspect immediately if the cameras could communicate with each other either directly or through a central computer. However current camera networks are typically performing a single imaging function individually and sending data back to a central computer. The central computer makes decisions based on the individual camera input not on a collective view of the camera network. Also, the camera network lacks the ability to adapt functions during a time critical event.

Therefore, it would be beneficial for the central computer to be able to look at images from a network of cameras collectively and change the function of these cameras based on this data. It would be more beneficial for the network of cameras to communicate with each other directly without going through a central computer. It would also be beneficial for the cameras to adapt their functions automatically in response to a trigger. A further need exists for a camera network to adapt its functions locally to track a suspect before they leave the local area.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a block diagram of a camera network according to an embodiment of the present invention.

FIG. 2 illustrates a block diagram of a camera in the camera network of FIG. 1 according to an embodiment of the present invention.

FIG. 3 illustrates a block diagram of a system comprising a camera network according to another embodiment of the present invention.

FIG. 4 illustrates a flow diagram depicting a method of changing a primary function of a camera in a camera network according to an embodiment of the present invention.

### DETAILED DESCRIPTION OF THE INVENTION

Before describing in detail embodiments that are in accordance with the present invention, it should be observed that the embodiments reside primarily in combinations of method steps and apparatus components related to a method and apparatus for an adaptive camera network. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

It will be appreciated that embodiments of the present invention described herein may be comprised of one or more conventional processors and unique stored program instructions that control the one or more processors to implement, in conjunction with certain non-processor circuits, some, most, or all of the functions of the method and apparatus for an adaptive camera network described herein. As such, these functions may be interpreted as steps of a method to perform changing a function of a camera in an adaptive camera network described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Generally speaking, pursuant to the various embodiments, the present invention is based on using a camera network, even an existing camera network, in combination with a software application, referred to herein as an application. The camera network comprises a plurality of cameras. The plurality of cameras can be linked using a wire or an optical fiber cable or by a known remote transmission mode. Software applications permit changing the camera function of at least one camera within the camera network when activated by a trigger. Changing the camera function based on the trigger offers several advantages. For example, a camera performing a primary function can be adapted to perform another function different from the primary function based on the need. Those skilled in the art will realize that the above recognized advantages and other advantages described herein are merely exemplary and are not meant to be a complete rendering of all of the advantages of the various embodiments of the present invention.

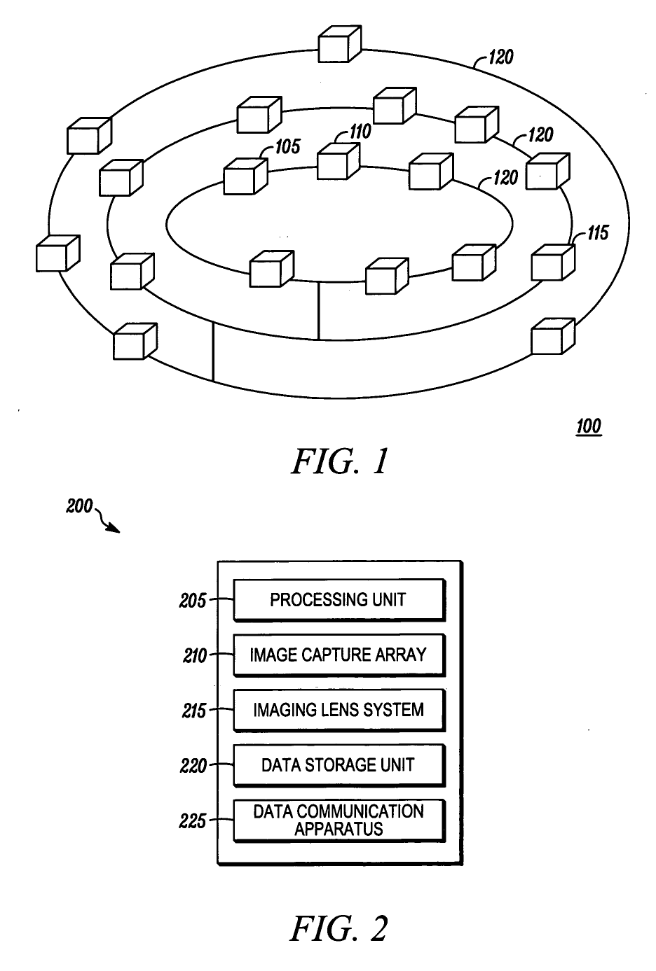

Referring now to the drawings, and in particular FIG. 1, a block diagram of a camera network is shown and indicated generally at 100. The camera network 100 comprises a plurality of cameras in communication 120 with each other. An illustration of a camera, pursuant to an embodiment of the present invention, which may comprise network 100 is shown in FIG. 2 and is described below in detail. The communication 120 can be enabled using at least one of a wireless protocol, such as the 802.xx protocol, the Internet and the Ethernet. 802.xx is a family of networking specifications developed by a working group of the Institute of Electrical and Electronics Engineers (IEEE). There are several specifications in the family, for example 802.11 protocol.

As per one embodiment, consider a first camera 105, a second camera 110 and a third camera 115 from the plurality of cameras in communication using a remote transmission mode of communication 120. In an alternate embodiment, each camera or a portion of the cameras from the plurality of cameras can also be connected to a server (not shown). The server (not shown) can be a central computer storing the software applications corresponding to specified functions. Alternatively, each camera may store the software applications corresponding to the specified functions. Each camera from the plurality of cameras can be configured to perform a primary function by executing at least one software application. The primary function of each camera may be the same or different, and both embodiments are within the scope of the present invention. As per one embodiment, the primary function of the camera can be changed on receiving a trigger from another camera in the plurality of cameras or on receiving a trigger from a user.

Turning now to FIG. 2, a block diagram of a camera in the camera network is shown and generally indicated at 200. Camera 200 may be, but is not limited to, one of a tollbooth camera, a license plate recognition camera, a surveillance camera, and a face recognition camera. According to an embodiment of the present invention, each camera 200 in the camera network 100 comprises a processing unit 205 that may be, for example, a microcontroller, a digital signal processor, a microprocessor, a stand alone state machine, etc., for managing image data and image analysis using an image analysis program that may include, for example, face detection, face tracking, car recognition, car tracking, license plate recognition, or optical character recognition. The image analysis program may be configured in software, in hardware, or any combination of software and hardware. Camera 200 further comprises a solid state image capture array 210 for capturing images and an imaging lens system 215 for focusing the image to be captured on the image capture array 210.

A memory illustrated as a data storage unit 220 is included and coupled to the processing unit and the image capture array and/or image lens system for storing software programs (including the image analysis program) and image data (e.g., digitized images). The data storage unit 220 can be a non-removable flash, electrically-programmable read only memory (FLASH EPROM), a dynamic random access memory (DRAM), static random access memory (SRAM), a hard disk drive, a floppy disk drive or a removable memory. The stored digital image representing a captured image is transmitted to the server or another camera in the network using data communication means.

Further, camera 200 comprises data communication apparatus 225 for retrieving and transmitting the stored digitized images to peripheral equipment (not shown) such as, for instance a personal computer, a server, a television, a printer, a compact disc player, a writer, a modem or an image capture device including other electronic cameras illustrated in the present invention. Such data communications can be by wire cable, infra-red light beams, optical fiber or radio frequency transmission. The details of these exemplary communication methods are well known in the art and will not be described in detail here for the sake of brevity. The camera network 100 includes upstream and downstream data and signal transmission for allowing cameras to communicate with each other in the camera network as well as to access the server. Data compression techniques may also optionally be employed to facilitate the transmission of the digitized image across a communication network.

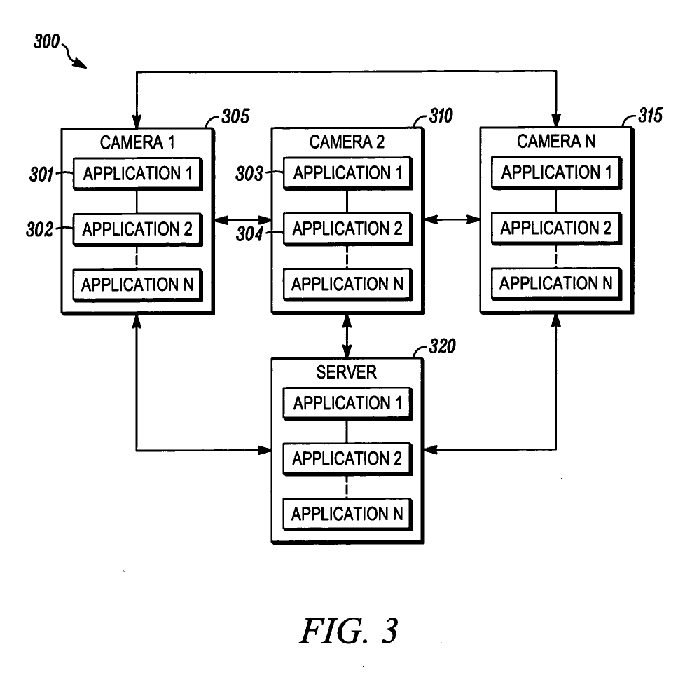

Turning now to FIG. 3, a block diagram of a system comprising a camera network is shown and generally indicated at 300 according to an embodiment of the present invention. The system 300 comprises a camera network illustrated using a first camera 305, a second camera 310 and a third camera 315. In order to show a practical example, only three cameras are shown pursuant to an embodiment of the present invention. However the camera network 300 may comprise several cameras, which shall be readily appreciated by one skilled in the art. Each camera in the camera network 300 generally comprises the elements and functionality described above by reference to camera 200 (FIG. 2) and further comprises a plurality of applications implemented as discrete applications or software programs, e.g., 1−N, or implemented as a single application or software program that can be executed using relaxed parameters. For example, the first camera 305 comprises applications 301, 302 and the second camera 310 comprises applications 303, 304. Each application performs a function, for instance application 301 on the first camera 305 and application 303 on the second camera 310 can perform the primary function for the respective cameras. Again, the number of applications available are not limited to the applications shown in FIG. 3 and can be varied based on the need and functions to be performed by the cameras, which shall be appreciated by one skilled in the art.

The application(s) for changing the function of the cameras can reside at each camera 305, 310 or at a central computer, for example, a server 320 operatively coupled to the cameras, the server being illustrated as comprising applications 1−N. Residing can generally mean the location where the application is originally stored prior to being needed or used in the cameras. The desired application, for instance a second application 302 can be uploaded to each camera on receiving a trigger, wherein a trigger is based on an event or occurrence, such as in an emergency, and is used to initiate a change in a camera's primary function. The cameras can communicate and download the application from the server via an 802.xx protocol such as the 802.11 protocol. Storing the applications on the central server 320 can reduce the resource requirement at each camera.

In one embodiment of the present invention, the trigger can be an input from a user of the camera network. For example, a network of cameras may be present in an airport or public space running an application that monitors faces or persons. When a time critical event has occurred (such as a person illegally going through airport security), an administrator (or user) of the system such as a law enforcement officer obtains image information, such as a facial photograph, of the suspect. The officer is then able to reprogram at least one or more cameras in the local area from having one set of parameters to having another set of parameters, for example the cameras where the suspect was last seen, to look specifically for this suspect. This would logically be the camera geographically closest to where the event occurred.

The officer may program the camera parameters to look for parameters including long hair, or a beard, or a red shirt or some other identifying feature. If one of these cameras registers a positive ID on the suspect through identifying at least one of the parameters in the second reprogrammed set, by partial recognition of the face, hair or clothing, this camera first sends an alert to the administrator and then sends information to other cameras geographically close in the network to program them to look for this same identifying feature. If a camera in this next set also gets a hit on the identifying feature, then this camera sends an alert and sends the features to the next geographically close set of cameras. In this way, the identifying feature can be tracked geographically through an airport or other crowded public space. Since the feature is not unique (for example, many individuals may be wearing a red shirt) several false positive hits may register. The false positives are acceptable due to the emergency, time critical nature of the event. The parameters can also be provided with different priorities set by a user. The priority indicates the level of preference to be given for each parameter when searching for the set of parameters.

The application software to reprogram the cameras may reside as a secondary application on the camera, may reside on a PC or a central computer or may be downloaded via the internet, for instance. The cameras may communicate with each other directly (in the case of a network of smart cameras) or they may communicate with each other through a PC or central computer. One requirement is that the processor that runs the secondary application software has to have sufficient memory and processing power for this particular application software.

In a second embodiment, the trigger may be self-actuated with no human intervention. For example, a network of cameras may be running a license plate recognition application and searching for license plates. The application is set up with a first set of parameters so that a “hit” or alert is registered if all 7 characters on the license plate match the incoming image. Some plates, however, (e.g., kidnappers, FBI most wanted, terrorists, etc.) may be tagged high priority, thus being predetermined in the network. If a hit is obtained on one of these predetermined high priority plates, the camera (or PC analyzing the image) automatically sends an alert to an administrator and then sends information to cameras geographically close to the hit to search specifically for this plate. The application searches specifically for this plate by registering a hit according to a second set of parameters (e.g., a 4 or 5 character match rather than a 7 character match). Again, more false positives will be registered using these relaxed parameters. In normal operation, this would be unacceptable, but is acceptable for this small geography area. After a set amount of time (e.g., upon the suspect being apprehended or noted to be out of area), the cameras will return to the first set of parameters, e.g., 7 character match parameters. Where in a further implementation of this embodiment a public safety or government official wants to track a suspect but not apprehend them, the camera network may store the information of the suspect's location (e.g., as associated with the geographical location(s) at or near his or her license plates hits) for several days or weeks. After a set amount of monitoring time, the public official may review the location of the individual and use it to apprehend the suspect, predict the future location of the suspect, or use the information as evidence of the suspect's whereabouts.

The application software to reprogram the cameras may reside as a secondary application on the camera, it may be reside on a PC, a central computer or may be downloaded via the internet. The cameras may communicate with each other directly (in the case of a network of smart cameras) or they may communicate with each other through a PC or central computer. One requirement is that the processor that runs the secondary application software has to have sufficient memory and processing power for this particular application software.

In yet another embodiment, each camera in the network can communicate with at least one other camera in the network to temporarily change the primary function of the camera, e.g., by changing parameters associated with the primary function. For example, a camera at a first tollbooth may capture an image of a suspect and actuate at least one other camera at other tollbooths to watch for the suspect. Details such as co-ordinates of the suspect can be captured using global positioning system (GPS) and other like technologies. Hence, a first portion of the camera network can be configured to perform a primary function such as license plate recognition whereas a second application may perform license plate recognition with relaxed parameters so that a geographical portion of the camera network can be configured to search for specific plates.

In a more sophisticated camera network, a first portion of the camera network can be configured to perform a primary function such as license plate recognition whereas a second portion of the camera network can be configured for a secondary function such as face recognition. This would require cameras with significantly more memory and features than are available currently.

In yet another embodiment of the present invention, executing the second application on the camera can change the primary function of the camera to a secondary function that is different from the primary function. For example, a primary function a camera may be license plate recognition that includes recognition of a number of alphabets and/or numbers. The secondary function may be, for example, face recognition and include a description of physical appearance of a person. Thus, on receiving a different set of parameters, the primary function of license plate recognition can be changed to the secondary function of face recognition using the second set of parameters.

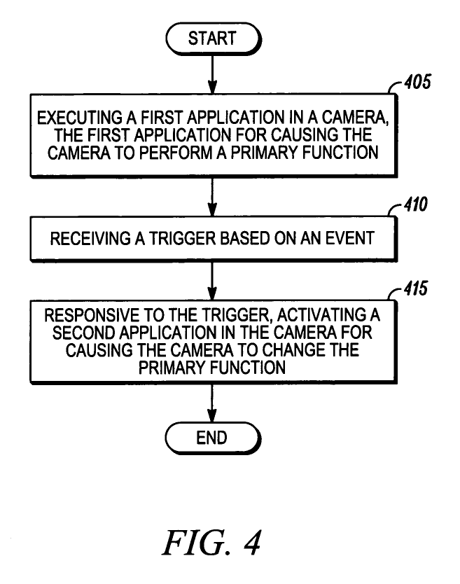

Turning now to FIG. 4, a flow diagram depicting a method of adapting a primary function of a camera in a camera network 100, 300 is shown according to an embodiment of the present invention. A first application 301 in a first camera 305 in the camera network 300 is executed to perform a primary function of the first camera 305, step 405. The primary function can be a license plate recognition function, a face recognition function, a surveillance function, a monitoring function, etc. Those skilled in the art shall realize that a camera can be configured to perform several functions and all such functions are within the scope of the present invention. The first camera 305 can receive a trigger based on an event step 410 and activate a second application 302 in response to the trigger, step 415. The second application 302 causes the first camera 305 to change the primary function.

As per one embodiment, the trigger can be a second camera 310 in the camera network 300 detecting the event. For example, the second camera 310 may detect a predetermined license plate and trigger the first camera 305 to change the primary function of the first camera 305 to search for the predetermined license plate.

Alternatively, the trigger can be a user input into the camera network 300. The user input can either execute the second application on a portion or all of the cameras in the camera network 300. The second application 302 can be executed on the first camera 305, for causing the first camera 305 to change the primary function to a secondary function that is different from the primary function. For example, the primary function of the first camera 305 can be license plate recognition. The second camera 310 can trigger the first camera 305 to execute a second application 302 that changes the primary function to a secondary function such as, for instance a surveillance function or a face recognition function.

In an embodiment of the present invention, at least one parameter from the second set of changes parameters corresponding to a function of the camera can comprise a priority. The priority can be set by a user. The priority indicates the level of preference to be given for a parameter when searching for the set of parameters. For example, the set of parameters for searching for a license plate comprises both alphabets and letters. A letter ‘K’ in the set of parameters can be given a higher priority than the numbers in the license plate. The cameras can capture many images or video clips similar to at least one of the parameter from the set of parameters.

In another embodiment of the present invention at least one of the applications can be modified to a modified application to adopt less accurate parameters when searching for a set of parameters. The modified application reduces a threshold of at least one parameter from the set of parameters. For example, the modified application reduces the accuracy of a license plate recognition camera to accept partial plates or poor images. The modified application can also reduce a threshold parameter while searching the face of a suspect. Hence the modified application configures a face recognition camera to look for a more general description of the face of the suspect.

The system and method provided in the present invention can be used to change the primary function of a camera locally and temporarily. For example turning a tollbooth camera into a license plate recognition camera or a face recognition camera.

An advantage of the present invention includes ability of a camera in a camera network to change the function of at least one other camera in the network. Hence the camera network can be used in a more effective way than confining the camera to a single function even in case of emergencies. This eliminates the inability to use a camera temporarily for high preference operations.

Yet another advantage of the present invention includes the ability to modify the application for adopting less accurate parameters when activated by a trigger. The system with a modified application can be used in airports, parking lots, hotels, border crossing and highways.

Application areas of the present invention include, but are not limited to, searching for crime suspects, searching for vehicles or objects of theft and searching for kidnapped people.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

What is claimed is:

1. A system comprising:
a camera network comprising a plurality of cameras, wherein each camera in the camera network comprises a plurality of applications that include a first application for performing a primary function and a second application for changing the primary function; and
a trigger based on an event, the trigger activating the second application in at least a portion of the plurality of cameras.

2. The system of claim 1, wherein the trigger is a first camera in the network detecting the event.

3. The system of claim 2, wherein the first camera detects a predetermined license plate and the detection activates the second application for searching for the predetermined license plate.

4. The system of claim 1, wherein the trigger is a user input into the camera network.

5. The system of claim 1, wherein the primary function is a license plate recognition function based on a first set of parameters, and the second application changes the first set of parameters to a second set of parameters.

6. The system of claim 1, wherein the second application changes the primary function to a secondary function that is different from the primary function.

7. The system of claim 1, wherein the second application resides on each camera, and the plurality of cameras communicate via a wireless protocol.

8. The system of claim 7, wherein the wireless protocol is an 802.xx protocol.

9. The system of claim 1, wherein the second application resides on each camera and, the plurality of cameras communicate via Internet.

10. The system of claim 1, wherein the second application resides on each camera, and the plurality of cameras communicate via Ethernet.

11. The system of claim 1, wherein the second application resides as software on a server and the second application is uploaded to each camera via an 802.xx protocol.

12. A method comprising the steps of:
executing a first application in a first camera comprising a plurality of cameras in a camera network, the first application for causing the first camera to perform a primary function;
receiving a trigger based on an event; and
responsive to the trigger, activating a second application in the first camera for causing the first camera to change the primary function.

13. The method of claim 12, wherein the trigger is a second camera in the network detecting the event.

14. The method of claim 13, wherein the second camera detects a predetermined license plate and the detection activates the second application in the first camera for searching for the predetermined license plate.

15. The method of claim 12, wherein the primary function is a face recognition function based on a first set of parameters, and the second application changes the first set of parameters to a second set of parameters.

16. The method of claim 12, wherein the primary function of the first camera is a surveillance function, and the second application causes the first camera to change the primary function to a secondary function that is different from the primary function.

17. The method of claim 12, wherein the trigger is a user input into the camera network.

18. The method of claim 17, wherein the user input comprises a set of parameters, the second application being activated in the first camera for causing the first camera to change the primary function on detecting at least one parameter from the set of parameters.

19. The method of claim 12, wherein the second application resides on each camera, and the plurality of cameras communicate via at least one of a wireless protocol, Internet and Ethernet.

20. The method of claim 12, wherein the second application resides as software on a server and the second application is uploaded to each camera via an 802.xx protocol.
